(19) United States
(12) Patent Application Publication
(10) Pub. No.: US 2019/0331644 A1
(43) Pub. Date: Oct. 31, 2019

(54) ADDITIVELY MANUFACURED PARTS AND RELATED METHODS

(71) Applicant: ARCONIC INC., Pittsburgh, PA (US)

(72) Inventors: Brandon H. Bodily, Broadview Heights, OH (US); Jared Friant, Plum, PA (US); Gen Satoh, Murrysville, PA (US); Gary A. Schaper, Pittsburgh, PA (US)

(21) Appl. No.: 16/509,067

(22) Filed: Jul. 11, 2019

Related U.S. Application Data
(63) Continuation of application No. PCT/US2018/015216, filed on Jan. 25, 2018.
(60) Provisional application No. 62/450,386, filed on Jan. 25, 2017.
(60) Provisional application No. 62/451,422, filed on Jan. 27, 2017.

(51) Int. Cl. G01N 29/11; B33Y 10/00; B33Y 50/00; B33Y 70/00; C22F 1/18; C22C 14/00; G01N 29/04

(52) U.S. Cl. CPC G01N 29/11; B33Y 10/00; B33Y 50/00; B33Y 70/00; G01N 2291/0289; C22C 14/00; G01N 29/043; G01N 2291/015; G01N 2291/0231; C22F 1/183

(57) ABSTRACT

In some embodiments, an exemplary method directed toward non-destructive methods of inspecting additively manufactured parts includes: additively manufacturing a metal part, the metal part configured with an additive manufacturing grain structure indicative of the type of additive process utilized to construct the metal part, wherein the grain structure is configured with a first ultrasonic signal attenuation level when assessed via ultrasonic inspection; imparting an amount of strain on the metal part to transform the additive manufacturing grain structure having a first ultrasonic signal attenuation level to a grain structure having second ultrasonic signal attenuation level, wherein the second ultrasonic signal attenuation level is lower than the first ultrasonic signal attenuation level; and inspecting the metal part via a non-destructive testing evaluation method to confirm whether the metal part passes a part build specification.

### CROSS REFERENCE TO RELATED APPLICATIONS

This application is a continuation of International Patent Application No. PCT/US2018/015216, filed Jan. 25, 2018, which claims benefit of U.S. provisional patent application Ser. No. 62/450,386, filed Jan. 25, 2017 and U.S. provisional patent application Ser. No. 62/451,422, filed Jan. 27, 2017.

### FIELD OF THE INVENTION

Embodiments of the present disclosure generally relate to additively manufactured parts. More specifically, embodiments of the present disclosure relate to non-destructive techniques to inspect additively manufactured parts.

### BACKGROUND

Using non-destructive techniques to inspect additively manufactured parts is an important aspect of ensuring the quality of additively manufactured parts and meeting build specifications.

### SUMMARY OF THE INVENTION

In some embodiments, a method is provided, comprising: additively manufacturing a metal part, the metal part configured with a first grain structure having a first amount of internal noise and a first amount of back wall signal attenuation when assessed via ultrasonic inspection; imparting an amount of strain on the metal part to transform the first grain structure to a second grain structure having a second amount of internal noise and a second amount of back wall signal attenuation, wherein the first amount of internal noise is greater than the second amount of internal noise; further wherein the first amount of back wall signal attenuation is greater than the second amount of back wall signal attenuation; and ultrasonically inspecting the metal part to obtain a result, wherein the imparting step configures the metal part with the second grain structure, which with the second amount of internal noise and second amount of back wall signal attenuation, is configured for ultrasonic evaluation.

In some embodiments, the first grain structure comprises an additive manufacturing grain structure indicative of the type of additive process utilized to construct the metal part.

In some embodiments, the first grain structure comprises columnar components.

In some embodiments, ultrasonically inspecting the metal part to obtain the result comprises confirming whether the metal part passes or fails a build specification for that part.

In some embodiments, a method is provided, comprising: additively manufacturing a metal part, the metal part configured with an additive manufacturing grain structure indicative of the type of additive process utilized to construct the metal part, wherein the additive manufacturing grain structure is configured with a first ultrasonic signal attenuation level when assessed via ultrasonic inspection; imparting an amount of strain on the metal part to transform the additive manufacturing grain structure having a first ultrasonic signal attenuation level to a grain structure having a second ultrasonic signal attenuation level, wherein the second ultrasonic signal attenuation level is lower than the first ultrasonic signal attenuation level; and inspecting the metal part via a non-destructive testing evaluation method to confirm whether the metal part passes a part build specification.

In some embodiments, inspecting the metal part via the non-destructive testing evaluation comprises ultrasonically inspecting the metal part.

In some embodiments, ultrasonically inspecting the metal part comprises identifying ultrasonic signal attenuations in the metal part that are indicative of at least one flaw in the metal part or deviation from a build specification.

In some embodiments, imparting an amount of strain on the metal part is configured to reduce an internal noise imparted on results of the ultrasonic inspection as compared to results from additive manufacturing grain structure.

In some embodiments, a method is provided, comprising: additively manufacturing a metal part, the metal part configured with an additive manufacturing grain structure indicative of the type of additive manufacturing process utilized to construct the metal part, wherein the grain structure is configured with a high ultrasonic signal attenuation when assessed via ultrasonic inspection; imparting a sufficient amount of strain on the metal part to transform the grain structure from an additively manufactured grain structure to a grain structure having reduced back wall signal attenuation in the metal part; and evaluating the metal part via an ultrasonic inspection to assess whether the part meets specifications; wherein the metal part is evaluable via the ultrasonic inspection via the imparting step.

In some embodiments, imparting a sufficient amount of strain on the metal part comprises imparting a sufficient amount of strain to transform an ultrasonically amenable grain structure to the metal part.

In some embodiments, imparting a sufficient amount of strain on the metal part comprises transforming the metal part to have a less ultrasonically attenuative configuration.

In some embodiments, upon ultrasonic evaluation, the metal part is configured with an ultrasonic signal amplitude of the back wall signal that is uniform per expectation based on part geometry.

In some embodiments, imparting a sufficient amount of strain on the metal part is configured to transform a first grain structure into a second grain structure, wherein the second grain structure is less attenuative when evaluated via ultrasonic inspection.

In some embodiments, imparting strain is completed via one or more strokes of a working step.

In some embodiments, imparting strain comprises working the metal part by at least one of: forging, rolling, ring rolling, ring forging, shaped rolling, extruding, and combinations thereof.

In some embodiments, after working the part, the metal part is annealed

In some embodiments, imparting strain comprises deforming the metal part to realize a true strain of at least 0.01 to not greater than 1.10 in the majority of the metal part, wherein the majority of the part is based on material volume.

In some embodiments, ultrasonically evaluating comprises at least one of phased array inspecting, laser UT inspecting, and combinations thereof.

In some embodiments, the specification is specific to at least one of the type of metal part, dimensions thereof, material(s) of construction, mechanical requirements, applications, and combinations thereof.

In some embodiments, the metal part is made from at least one of metals or alloys of titanium, aluminum, titanium-aluminide, nickel (e.g., INCONEL), steel, stainless steel, and combinations thereof.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a graph detailing an embodiment of measuring back reflection via ultrasonic evaluation, in accordance with some embodiments of the instant disclosure.

FIG. 2 depicts a snapshot of an ultrasonic evaluation of the internal amplitude of return in an as-built sample as compared to that of a forged sample, in accordance with some embodiments of the instant disclosure.

FIG. 3 depicts a snapshot of an ultrasonic evaluation of the internal amplitude of return of the back wall in an as-built sample as compared to that of a forged sample, in accordance with some embodiments of the instant disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

As used herein, “additive manufacturing” means: a process of joining materials to make objects from 3D model data, usually layer upon layer, as opposed to subtractive manufacturing methodologies.

As used herein, “additive systems” means machines and related instrumentation used for additive manufacturing.

As used herein, “direct metal laser sintering” means a powder bed fusion process used to make metal parts directly from metal powder without intermediate “green” or “brown” parts.

As used herein, “directed energy deposition” means an additive manufacturing process in which focused thermal energy is used to fuse materials by melting as they are being deposited.

As used herein, “laser sintering” means a powder bed function process used to produce objects from powdered materials using one or more lasers to selectively fuse or melt the particles at the surface, layer by layer, in an enclosed chamber.

As used herein, “powder bed fusion” means an additive manufacturing process in which thermal energy selectively fuses regions of a powder bed.

In some embodiments, “back wall signal” is defined as the strength of the signal returning from the back surface, as oriented normal to the direction of sound propagation, through the bulk of the part during ultrasonic evaluation.

Generally, the strength of that back wall signal can be indicative of how noisy, or attenuative, the part under evaluation is. If no signal from the back wall is received, it is thought to be a strong indicator (under the right settings) that the part under evaluation has a severe degree of ultrasonic signal attenuation resultant from internal discontinuities. In some embodiments, internal discontinuities include but are not limited to air-filled voids. As such, the back wall signal is a factor of indicating or assessing part quality via ultrasonic evaluation. The level of the back wall return signal may be a criterion in a specification, where a specified amount of loss of back wall signal (or attenuation) would result in the part being rejected.

In some embodiments, a method is provided, comprising: additively manufacturing a metal part, the metal part configured with an additive manufacturing grain structure indicative of the type of additive process utilized to construct the metal part, wherein the grain structure is configured with a first ultrasonic signal attenuation level when assessed via ultrasonic inspection; imparting an amount of strain on the metal part to transform the additive manufacturing grain structure having a first ultrasonic signal attenuation level to a grain structure having a second ultrasonic signal attenuation level, wherein the second ultrasonic signal attenuation level is lower than the first ultrasonic signal attenuation level; and ultrasonically inspecting the metal part to obtain a result, wherein the imparting step configures the metal part with the second ultrasonic signal attenuation level such that the part is configured for ultrasonic evaluation.

In some embodiments, a method is provided, comprising: additively manufacturing a metal part, the metal part configured with a first grain structure having a first amount of internal noise and a first amount of back wall signal attenuation when assessed via ultrasonic inspection; imparting an amount of strain on the metal part to transform the first grain structure to a second grain structure having a second amount of internal noise and a second amount of back wall signal attenuation, wherein the first amount of internal noise is greater than the second amount of internal noise; further wherein the first amount of back wall signal attenuation is greater than the second amount of back wall signal attenuation; and ultrasonically inspecting the metal part to obtain a result, wherein the imparting step configures the metal part with the second grain structure, which with the second amount of internal noise and second amount of back wall signal attenuation, is configured for ultrasonic evaluation.

In some embodiments, the first grain structure is configured with a highly oriented grain structure. In some embodiments, the first grain structure comprises an additive manufacturing grain structure. In some embodiments, the first grain structure is dependent upon the additive manufacturing (AM) build material, the AM process and/or machine, and the process parameters utilized on the additive manufacturing build.

In some embodiments, the first grain structure is configured with a highly oriented (e.g. observable) distinctive pattern or banding.

In some embodiments, the first grain structure is configured with some patterning/banding in the grain structure (e.g., observable and/or quantifiable via the ultrasound backwall return signal).

In some embodiments, the first grain structure is configured such that it results in a highly oriented distinctive pattern or banding in the UT backwall return.

In some embodiments, the second grain structure is configured as random and/or non-distinctive patterning and/or banding.

In some embodiments, the first grain structure comprises an additive manufacturing grain structure.

In some embodiments, the additive manufacturing grain structure indicative of the type of additive process utilized to construct the metal part.

In some embodiments, the grain structure comprises columnar components.

In some embodiments, the grain structure comprises a highly oriented structure having a plurality of bands indicative of bead paths or additive energy source melting and/or deposition pathways having distinct bands and/or patterns.

In some embodiments, ultrasonically inspecting the metal part to obtain a result comprises confirming whether the part passes or fails a build specification for that part.

In some embodiments, a method is provided, comprising: additively manufacturing a metal part, the metal part configured with an additive manufacturing grain structure indicative of the type of additive process utilized to construct the metal part, wherein the grain structure is configured with a first ultrasonic signal attenuation level when assessed via ultrasonic inspection; imparting an amount of strain on the metal part to transform the additive manufacturing grain structure having a first ultrasonic signal attenuation level to a grain structure having a second attenuation rate, wherein the second ultrasonic signal attenuation level is lower than the first ultrasonic signal attenuation level; and inspecting the metal part via a non-destructive testing evaluation method to confirm whether the metal part passes a part build specification.

In some embodiments, inspecting the metal part via a non-destructive testing evaluation comprises ultrasonically inspecting the metal part.

In some embodiments, the imparting step is configured to reduce signal attenuations in the ultrasound evaluation, as compared to the results obtainable from the first grain structure (e.g. additive grain structure).

In some embodiments, the imparting step is configured to reduce the internal noise and back wall signal attenuation attributable to the additive grain structure, to enable assessment and identification of ultrasonic signal attenuation or ultrasonic indications (if any) attributable to a discontinuities in the metal part and/or deviation from a build specification.

In some embodiments, ultrasonically evaluating includes identifying ultrasonic signal attenuation or ultrasonic indications in the metal part that are indicative of part discontinuities in the metal part and/or deviations from a build specification.

In some embodiments, ultrasonic signal attenuation reduced and/or prevented with one or more of the described methods are indicative of back wall signal strength; internal noise, and combinations thereof from the first grain structure (e.g. additive grain structure).

In some embodiments, the imparting step is configured to reduce the internal noise imparted on the ultrasonic evaluation results as compared to the results from the first grain structure (e.g. additive grain structure).

In some embodiments, the imparting step is configured to eliminate the internal noise imparted on the ultrasonic evaluation results as compared to the results from the first grain structure (e.g. additive grain structure).

In some embodiments, a method is provided, comprising: additively manufacturing a metal part, the metal part configured with an additive manufacturing grain structure indicative of the type of additive process utilized to construct the metal part, wherein the grain structure is configured with a high ultrasonic signal attenuation when assessed via ultrasonic inspection; imparting a sufficient amount of strain on the metal part to transform the grain structure from an additively manufactured grain structure to a grain structure having reduced back wall signal attenuation in the part; evaluating the metal part via a nondestructive testing method (e.g. ultrasonic inspection) to assess whether the part meets specifications (e.g. pass/fail); wherein the metal part is evaluable via non-destructive testing NDT via the imparting step.

In some embodiments, imparting comprises imparting a sufficient amount of strain to transform or impart an ultrasonically amenable grain structure to the metal part.

In some embodiments, the imparting step comprises transforming the metal part to have a less ultrasonically attenuative configuration.

In some embodiments, upon ultrasonic evaluation, the metal part is configured with an ultrasonic signal amplitude of the back wall signal that is uniform and/or consistent (e.g. per expectation based on part geometry) and for example is configured such that the part has reduced irregularities, or is defined as being acoustically similar within itself.

In some embodiments, acoustically similar means within a threshold acoustic value.

In some embodiments, acoustically similar means within +/− 10% Full Scale Height (FSH).

In some embodiments, consistent loss of back wall reflection is quantifiable by a test performed in accordance with AMS-STD-2154's (e.g. including a requirement for back wall signal attenuation is no loss greater than 50% FSH).

In some embodiments, imparting strain is configured to transform the first grain structure (e.g. microstructure) into a second grain structure (e.g. microstructure), wherein the second grain structure is less attenuative when evaluated via ultrasonic inspection. For example, with the second grain structure the metal part has less failures compared against a part build specification for unnecessary reasons (e.g. provided that the build specification/criterion includes a back wall signal attenuation measurement.)

In some embodiments, the additively manufacturing a metal part step utilizes directed energy deposition (e.g. EBAM, wire feed electron beam additive manufacturing, plasma arc, LENS). In some embodiments, the additively manufacturing a metal part utilizes selective laser melting (e.g. powder bed process (e.g. EOS)).

In some embodiments, imparting strain is completed on a portion of the metal part. In some embodiments, imparting strain is completed on the entirety of the metal part. In some embodiments, imparting strain is completed in a direction normal to the AM build direction. In some embodiments, imparting strain is completed in a direction orthogonal to the AM build direction. In some embodiments, imparting strain is completed in a direction transverse to the AM build direction. In some embodiments, imparting strain is completed in a direction that is arbitrary with respect to the AM build direction.

By imparting strain, the final metal part may realize improved properties, such as grain structure which is amenable to non-destructive testing/filtering out of noise and aberrations attributable to additively formed parts. Other properties include, as examples, improved porosity (e.g., lower porosity), improved surface roughness (e.g., less surface roughness or smoother surface), and/or better mechanical properties (e.g., improved surface hardness), among others.

In some embodiments, imparting strain is completed via a single stroke/pass of a deforming and/or working step. In some embodiments, imparting strain is completed via a plurality of strokes/passes of a deforming and/or working step.

In some embodiments, imparting strain comprises working the metal part by at least one of: forging, rolling, ring rolling, ring forging, shaped rolling, extruding, and combinations thereof.

In some embodiments, metal parts or products are formed into shapes via forging operations. To forge metal products, several successive dies (e.g. flat dies and/or differently shaped dies) may be used for each part, with the flat die or the die cavity in a first of the dies being designed to deform the forging stock to a first shape defined by the configuration of that particular die, and with the next die being shaped to perform a next successive step in the forging deformation of the stock, and so on, until the final die ultimately gives the forged part a fully deformed shape.

In one aspect, the forging step may comprise heating the metal-shaped preform to a stock temperature. In one approach, the metal shaped preform is heated to a stock temperature of from 850° C. to 978° C. In some embodiments, the metal shaped preform is heated to a stock temperature of from 890° C. to 978° C. In some embodiments, the metal shaped preform is heated to a stock temperature of from 910° C. to 978° C. In some embodiments, the metal shaped preform is heated to a stock temperature of from 930° C. to 978° C. In some embodiments, the metal shaped preform is heated to a stock temperature of from 950° C. to 978° C. In some embodiments, the metal shaped preform is heated to a stock temperature of from 970° C. to 978° C. In some embodiments, the metal shaped preform is heated to a stock temperature of from 890° C. to 970° C. In some embodiments, the metal shaped preform is heated to a stock temperature of from 890° C. to 950° C. In some embodiments, the metal shaped preform is heated to a stock temperature of from 890° C. to 930° C. In some embodiments, the metal shaped preform is heated to a stock temperature of from 890° C. to 910° C.

In one aspect, after the forging step (or other working or deformation steps set out above) the metal part or product is optionally annealed. The annealing step may facilitate the relieving of residual stress in the metal part due to the forging step.

In one embodiment, when the metal shaped-preform comprises a Ti-6Al-4V alloy, the annealing step may comprise heating the final forged product to a temperature of from about 640° C. to about 816° C. In some embodiments, the annealing step may comprise heating the final forged product to a temperature of from about 680° C. to about 816° C. In some embodiments, the annealing step may comprise heating the final forged product to a temperature of from about 720° C. to about 816° C. In some embodiments, the annealing step may comprise heating the final forged product to a temperature of from about 760° C. to about 816° C. In some embodiments, the annealing step may comprise heating the final forged product to a temperature of from about 800° C. to about 816° C. In some embodiments, the annealing step may comprise heating the final forged product to a temperature of from about 640° C. to about 800° C. In some embodiments, the annealing step may comprise heating the final forged product to a temperature of from about 640° C. to about 760° C. In some embodiments, the annealing step may comprise heating the final forged product to a temperature of from about 640° C. to about 720° C. In some embodiments, the annealing step may comprise heating the final forged product to a temperature of from about 640° C. to about 680° C.

In some embodiments, the imparting strain step comprises applying a sufficient force to the metal part via the deforming and/or working step to realize a pre-selected amount of true strain in the metal part.

As used herein “true strain” (εₜᵣᵤₑ) is given by the formula: εₜᵣᵤₑ=1n(L/L₀), where L₀ is initial length of the material and L is the final length of the material. In some embodiments, true strain refers to that portion of the product subject to ultrasonic inspection.

In some embodiments, imparting strain comprises deforming the metal part (e.g. via a working step) to realize a true strain of at least 0.01 to not greater than 1.10 in In some embodiments, imparting strain comprises deforming the metal part (e.g. via a working step) to realize a true strain of at least 0.01 to not greater than 1.10 in the majority of the metal part, wherein the majority of the part is based on material volume. In some embodiments, imparting strain comprises deforming the metal part (e.g. via a working step) to realize a true strain of at least 0.01 to not greater than 1.10 in a portion of the metal part.

In some embodiments, the true strain is: at least 0.01; at least 0.025; at least 0.05; at least 0.075; at least 0.1; at least 0.15; least 0.2; at least 0.25; at least 0.30; at least 0.35; least 0.4; at least 0.45; at least 0.50; at least 0.55; least 0.6; at least 0.65; at least 0.70; at least 0.75; least 0.8; at least 0.85; at least 0.9; at least 0.95; least 1.0; or at least 1.10 in the metal part.

In some embodiments, the true strain is: not greater than 0.025; not greater than 0.05; not greater than 0.075; not greater than 0.1; not greater than 0.15; not greater than 0.2; not greater than 0.25; not greater than 0.30; not greater than 0.35; least 0.4; not greater than 0.45; not greater than 0.50; not greater than 0.55; least 0.6; not greater than 0.65; not greater than 0.70; not greater than 0.75; least 0.8; not greater than 0.85; not greater than 0.9; not greater than 0.95; least 1.0; or not greater than 1.10 in the metal part.

In some embodiments, the true strain is 0.01 to 0.5. In some embodiments, the true strain is 0.05 to 0.75. In some embodiments, the true strain is 0.25 to 0.75. In some embodiments, the true strain is 0.01 to 0.15. In some embodiments, the true strain is 0.01 to 0.05. In some embodiments, the true strain is 0.01 to 0.6. In some embodiments, the true strain is less than 0.01. In some embodiments, the true strain is greater than 1.10.

In some embodiments, ultrasonically evaluating the metal part includes at least one of phased array inspecting, laser ultrasonic inspecting, and combinations thereof.

In some embodiments, the build specification is specific to at least one of the type of metal part, dimensions thereof, material(s) of construction, mechanical requirements, applications, and combinations thereof.

In some embodiments, the metal part is ultrasonically evaluated in accordance with a build specification for aerospace products (e.g. AMS-STD-2154 or other governing body specifications).

In some embodiments, the metal part produced by the additive manufacturing step is made from any metal suited for both additive manufacturing and forging, including, for example metals or alloys of titanium, aluminum, titanium-aluminide, nickel (e.g., INCONEL), steel, and stainless steel, among others. In one embodiment, the metal part comprises at least one of titanium, aluminum, titanium-aluminide, nickel, steel, stainless steel, and combinations thereof.

In one embodiment, the metal shaped-preform may be a titanium alloy (e.g. a Ti-6Al-4V alloy). An alloy of titanium is an alloy having titanium as the predominant alloying element. In another embodiment, the metal shaped-preform may be an aluminum alloy. An alloy of aluminum is an alloy having aluminum as the predominant alloying element. In yet another embodiment, the metal shaped-preform may be a nickel alloy. An alloy of nickel is an alloy having nickel as the predominant alloying element.

In yet another embodiment, the metal shaped-preform may be one of a steel and a stainless steel. An alloy of steel is an alloy having iron as the predominant alloying element, and at least some carbon. An alloy of stainless steel is an alloy having iron as the predominant alloying element, at least some carbon, and at least some chromium.

In another embodiment, the metal shaped-preform may be a metal matrix composite.

In yet another embodiment, the metal shaped-preform may comprise titanium aluminide. For example, in one embodiment, the titanium alloy may include at least 48 wt. % Ti and at least one titanium aluminide phase, wherein the at least one titanium aluminide phase is selected from the group consisting of Ti₃Al, TiAl and combinations thereof.

In another embodiment, the titanium alloy includes at least 49 wt. % Ti. In yet another embodiment, the titanium alloy includes at least 50 wt. % Ti. In another embodiment, the titanium alloy includes 5-49 wt. % aluminum. In yet another embodiment, the titanium alloy includes 30-49 wt. % aluminum, and the titanium alloy comprises at least some TiAl. In yet another embodiment, the titanium alloy includes 5-30 wt. % aluminum, and the titanium alloy comprises at least some Ti₃Al.

In some embodiments, a machining step is completed on the surface of the metal-shaped part, such that non-destructive testing (NDT) has a normalized surface (generally flat, with low surface roughness).

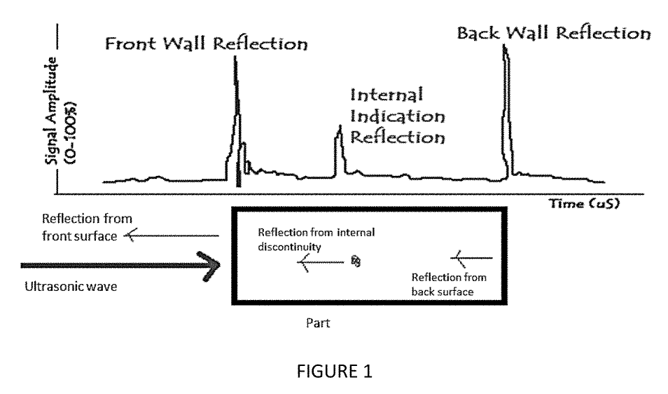

FIG. 1 depicts a graph detailing an embodiment of measuring back reflection via ultrasonic evaluation, in accordance with some embodiments of the instant disclosure. Without being bound by any particular mechanism or theory, the graph provided in FIG. 1 is a pictorial representation of back reflection.

With reference to FIG. 1, as an ultrasonic soundwave propagates through a material (water, metal part, air gap, etc.), it travels at a particular speed and in a particular manner. Any time the signal encounters an interface with a different material (from water to a metal part surface for example) it sees an acoustic impedance mismatch and that causes some percent of the incident wave to be reflected back. Internal discontinuities can cause reflections, but so can the back wall of the part.

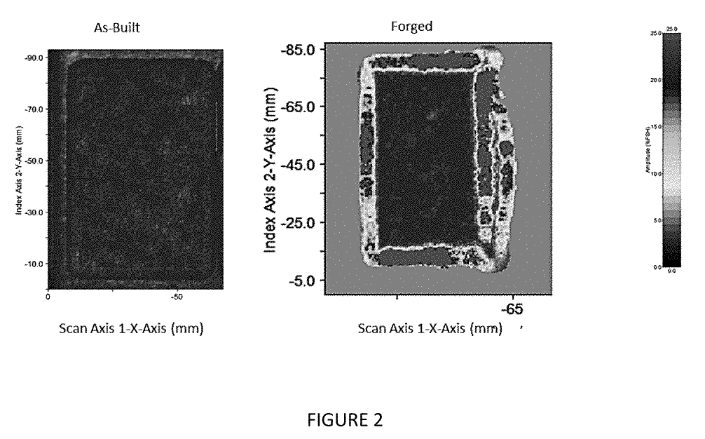

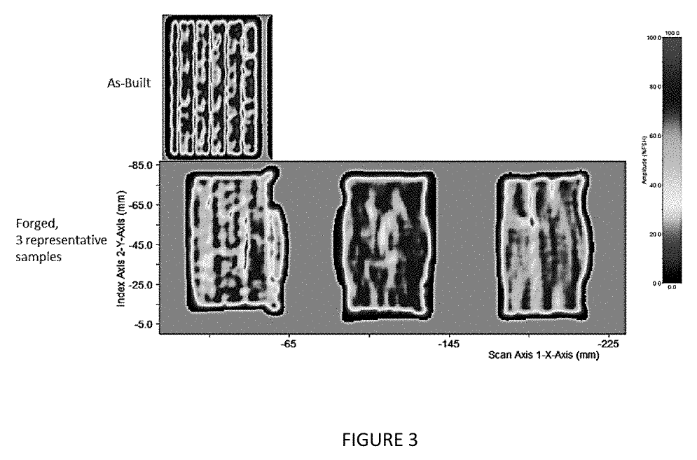

FIGS. 2-3 are representative of an experiment performed on additively manufactured parts that were deformed in a deformation simulator, which was configured to impart strain on the additively manufactured metal part.

Additively manufactured parts built via an EBAM process were subjected to a proxy forging operation (imparted via a deformation simulator). The simulator was configured as two flat plates that fit on opposing outer surfaces of the additively manufactured part. The plates imparted a force onto the part, thus imparting a strain in the part. The internal structure of the deformed samples was evaluated via ultrasonic inspection and compared against a representative build (having representative thickness) to evaluate whether the imparting step reduced attenuations in the metal part that were attributable to the additively manufactured grain structure of the part.

For example, to enable a comparison, one sample was machined from the as-built state;

while the corresponding sample was built over-sized and then forged to approximately the same dimensions, thickness in particular, as the as-built sample.

Both sets of samples (As-Built and Forged) were evaluated using immersion ultrasound. The ultrasonic evaluation was completed on a system that included ScanView Plus software and associated immersion tank system equipped with a manipulator and leveling table.

Details of the ultrasonic evaluation are as follows: the water path to front was 48 microseconds, the scan/index increments were 0.5 mm, no TCG/DAC was used, a 10 MHz, flat-bottom, 0.25″ diameter transducer was used, and the gain setting was variable.

For initial “internal amplitude” evaluation, the system was calibrated to an ASTM E-127 Reference Block (2″ material path, 2/64″ flat-bottomed hole) at 80% FSH. For “loss of back” evaluations, the gain was decreased to a setting determined for each given set of parts to ensure no saturation of the back signal. Results from both the ultrasonic evaluation were compared for any distinguishing differences.

FIG. 2 depicts a snapshot of the internal amplitude of return in the as-built sample and compared to the internal amplitude of return of the forged sample. These scans were performed at a gain setting of 66.8 dB, based on an 80% FSH return of the 2-0200 ASTM E-127 Reference Block.

FIG. 2 shows that, discounting the ultrasonic signal at the perimeter of the forged sample due to bulging, the strength of the ultrasonic signals returning from inside the as-built sample to the transducer is the same as, or substantially the same as (e.g. the same shading), the strength of the ultrasonic signals returning from inside the forged sample to the transducer.

For the purposes of the evaluation, any indication 80% FSH or greater would be equivalent to the ultrasonic signal of a 2/64″ diameter flat-bottomed hole. Any indication above 40% FSH would be considered questionable and require additional evaluation. No such indications existed in the as-built sample or the forged sample of FIG. 2.

Regarding the forged sample, it is noted that the irregular shapes and the edge effect at the perimeter of the forged sample were due to bulging caused by the forging process. As before, no indications greater than 15% FSH were observed in areas of the forged sample inside the perimeter of the forged sample.

Without being bound by any particular mechanism or theory, it was observed that the forging process did not appear to cause any internal discontinuities (cracking, etc.) based on the similar strength of the ultrasonic signals returning from inside the forged sample to the transducer.

Referring to FIG. 3, for this scan, the gain was decreased until a typical back surface amplitude of 80% FSH was obtained (47 db for as built, 46 db for forged). This provided more sensitivity to internal attenuation when monitoring the back wall amplitude.

FIG. 3 shows the strength of the back wall signal in an as-built sample and in three forged samples. The amplitude of this returning signal can indicate areas within the sample that are more attenuative than others, i.e. a weaker signal reaches the back, thus a weaker signal from the back reflection reaches the transducer.

For a completely uniform part (e.g. a part having equiaxed grain structure, no internal discontinuities, etc.) this amplitude of the back wall scan should present a consistent and uniform shade. However, this was not the case for the as-built sample. For the as-built sample, the amplitude of the back wall signal ranges from 100% FSH down to below 20% FSH; any attenuation of greater than 10% FSH would be cause for further investigation for lack of consistency. Not only was the degree of attenuation of note, but also the patterns shown in the sample which corresponded to the AM pattern.

Without being bound by a particular mechanism or theory, FIG. 3 shows that in the as-built sample, the interfaces (e.g. vertical lines in the as-built sample of FIG. 3) between the deposited layers themselves, as well as the interface between the deposited layers and the build plate, are detectable through the monitoring of the back wall amplitude.

In comparison, in the forged samples a distinct patterning at the interface between the deposited material and build plate was observed in the left-most sample. However, the patterns corresponding to interfaces between the deposited layers appeared to be less distinct than the as-built sample, though only marginally. The remaining forged samples showed a much less distinct patterning and more uniformity/consistency as compared to the as-built sample.

The forged parts were observed to have fewer areas of high attenuation of the back wall amplitude and more consistent time of flight to the back wall as compared to the as-built AM parts. Without being bound by a particular mechanism or theory, the nature of the deformation simulator (plates at a temperature lower than the sample material to be forged) used to apply the forging force may have resulted in a localized “freezing” of the near platen surface of the samples, effectively reducing the amount of deformation and/or only deforming the interior portion of the samples.

If the aforementioned characteristic applied for this evaluation assessment, it is believed to be overcome with commercial scale processes (e.g. which employ higher temperature heated forging surfaces or preheating steps and samples with greater thermal mass to resist surface cooling), such that further reductions in attenuations attributable to microstructure are believed to be achievable (e.g. and ultrasonic detectability increased on AM built parts).

Without being bound by a particular mechanism or theory, it was observed that the forging process via the deformation simulator appeared to have reduced the impact of the interfaces (AM grain structure), particularly between deposited material strips/bead paths.

In some embodiments, imparting strain on an AM built part reduces the number of attenuations detectable in an ultrasonically evaluated part. Thus, a combination of ultrasonic parameters, including: internal amplitude, internal time of flight, back wall amplitude, back wall time of flight, and combinations thereof, can be utilized to evaluate AM built metal parts as a non-destructive testing method to assess whether a part is built to specification.

While a number of embodiments of the present invention have been described, it is understood that these embodiments are illustrative only, and not restrictive, and that many modifications may become apparent to those of ordinary skill in the art, including that the inventive methodologies, the inventive systems, and the inventive devices described herein can be utilized in any combination with each other. Further still, the various steps may be carried out in any desired order (and any desired steps may be added and/or any desired steps may be eliminated).

We claim:

1. A method, comprising:
additively manufacturing a metal part, the metal part configured with a first grain structure having a first amount of internal noise and a first amount of back wall signal attenuation when assessed via ultrasonic inspection;
imparting an amount of strain on the metal part to transform the first grain structure to a second grain structure having a second amount of internal noise and a second amount of back wall signal attenuation,
wherein the first amount of internal noise is greater than the second amount of internal noise;
further wherein the first amount of back wall signal attenuation is greater than the second amount of back wall signal attenuation; and
ultrasonically inspecting the metal part to obtain a result, wherein the imparting step configures the metal part with the second grain structure, which with the second amount of internal noise and second amount of back wall signal attenuation, is configured for ultrasonic evaluation.

2. The method of claim 1, wherein the first grain structure comprises an additive manufacturing grain structure indicative of the type of additive process utilized to construct the metal part.

3. The method of claim 1, wherein the first grain structure comprises columnar components.

4. The method of claim 1, wherein ultrasonically inspecting the metal part to obtain the result comprises confirming whether the metal part passes or fails a build specification for that part.

5. A method, comprising:
additively manufacturing a metal part, the metal part configured with an additive manufacturing grain structure indicative of the type of additive process utilized to construct the metal part, wherein the additive manufacturing grain structure is configured with a first ultrasonic signal attenuation level when assessed via ultrasonic inspection;
imparting an amount of strain on the metal part to transform the additive manufacturing grain structure having a first ultrasonic signal attenuation level to a grain structure having a second ultrasonic signal attenuation level, wherein the second ultrasonic signal attenuation level is lower than the first ultrasonic signal attenuation level; and
inspecting the metal part via a non-destructive testing evaluation method to confirm whether the metal part passes a part build specification.

6. The method of claim 5, wherein inspecting the metal part via the non-destructive testing evaluation comprises ultrasonically inspecting the metal part.

7. The method of claim 6, wherein ultrasonically inspecting the metal part comprises identifying ultrasonic signal attenuations in the metal part that are indicative of at least one flaw in the metal part or deviation from a build specification.

8. The method of claim 6, wherein the imparting step is configured to reduce an internal noise imparted on results of the ultrasonic inspection as compared to results from additive manufacturing grain structure.

9. A method, comprising:
additively manufacturing a metal part, the metal part configured with an additive manufacturing grain structure indicative of the type of additive manufacturing process utilized to construct the metal part, wherein the grain structure is configured with a high ultrasonic signal attenuation when assessed via ultrasonic inspection;
imparting a sufficient amount of strain on the metal part to transform the grain structure from an additively manufactured grain structure to a grain structure having reduced back wall signal attenuation in the metal part; and
evaluating the metal part via an ultrasonic inspection to assess whether the part meets specifications;
wherein the metal part is evaluable via the ultrasonic inspection via the imparting step.

10. The method of claim 9, wherein imparting comprises imparting a sufficient amount of strain to transform an ultrasonically amenable grain structure to the metal part.

11. The method of claim 9, wherein the imparting step comprises transforming the metal part to have a less ultrasonically attenuative configuration.

12. The method of claim 9, wherein upon ultrasonic evaluation, the metal part is configured with an ultrasonic signal amplitude of the back wall signal that is uniform per expectation based on part geometry.

13. The method of claim 9, wherein the imparting step is configured to transform a first grain structure into a second grain structure, wherein the second grain structure is less attenuative when evaluated via ultrasonic inspection.

14. The method of claim 9, wherein imparting strain is completed via one or more strokes of a working step.

15. The method of claim 9, wherein imparting strain comprises working the metal part by least one of: forging, rolling, ring rolling, ring forging, shaped rolling, extruding, and combinations thereof.

16. The method of claim 15, wherein after working the part, the metal part is annealed.

17. The method of claim 9, wherein imparting strain comprises deforming the metal part to realize a true strain of at least 0.01 to not greater than 1.10 in the majority of the metal part, wherein the majority of the part is based on material volume.

18. The method of claim 9, wherein ultrasonically evaluating comprises at least one of phased array inspecting, laser UT inspecting, and combinations thereof.

19. The method of claim 9, wherein the specification is specific to at least one of the type of metal part, dimensions thereof, material(s) of construction, mechanical requirements, applications, and combinations thereof.

20. The method of claim 9, wherein the metal part is made from at least one of metals or alloys of titanium, aluminum, titanium-aluminide, nickel (e.g., INCONEL), steel, stainless steel, and combinations thereof.
